(19) United States
(12) Patent Application Publication
(10) Pub. No.: US 2003/0036858 A1
(43) Pub. Date: Feb. 20, 2003

(54) Apparatus for deformation and/or movement detection

(76) Inventors: Arnd Friedrichs, Jena (DE); Ulf Kletzin, Jena (DE)

Correspondence Address: Jeffrey R. Ambroziak, BACHMAN & LaPOINTE, P.C., Suite 1201, 900 Chapel Street, New Haven, CT, 06510-2802, US

(21) Appl. No.: 10/157,389

(22) Filed: May 28, 2002

(30) Foreign Application Priority Data
May 30, 2001 (DE) 10126539.5

(51) Int. Cl. G01L 1/00; G01L 3/00; G01L 5/00; G06F 19/00

(52) U.S. Cl. 702/41

(57) ABSTRACT

The invention concerns an apparatus for deformation and/or movement detection, comprising a pair of preferably piezoelectrically acting sensor units co-operating on an ultrasound basis, and an electronic measuring unit which is connected downstream of the pair of sensor units and which is adapted to produce a deformation or movement signal on the basis of electronically evaluatable signals of the sensor units, corresponding to a change in spacing between the pair of sensor units, wherein associated with the pair of sensor units is a fixing unit for releasably fixing the sensor units to an object to be measured, in particular to a part of the body of a person, and the pair of sensor units is ultrasound-conductingly connected by a holding device which has an elastic and/or deformable spacing medium and which is so adapted that deformation of the spacing medium to produce the deformation or movement signal is detectable by the measuring unit.

### BACKGROUND OF THE INVENTION

(1) Field of the Invention

The present invention concerns an apparatus for deformation and/or movement detection by means of a pair of ultrasonic sensors, wherein the electronic measuring unit connected on the output side of the ultrasonic sensors can ascertain the deformation and/or movement signal on the basis of changes in spacing between the sensor units (corresponding then to transit time differences of the signal between the sensor units).

(2) Description of the Related Art

The related art discloses both processes which measure the pure transit time between two sensors, and also processes which measure a signal reflected by a transmitter (pulse echo method).

Particularly when such a known measurement operation however is effected through air or other gases, the measurement signal would be detrimentally influenced by reflection at boundary layers, by changes in temperature, ambient sound or—in general terms—an indeterminate, substantially diffuse signal and propagation pattern or configuration in or at an object to be measured. That is particularly critical when the ultrasound is coupled directly into the medium to be investigated, which for example takes place in the area of material testing. The problems due to propagation in air occur in particular when the pair of sensor units is arranged as transmitter or receiver at a defined spacing in opposite relationship with each other.

It is also known in the art to use ultrasonic sensors in relation to imaging methods in medical diagnostics, for example in the sector of pregnancy or organ diagnostics. In that method the skin or the human body itself serves as the transmission medium. This also applies in regard to those uses in which, based on the variations in the spacing of a pair of ultrasonic sensors applied to the skin, detection of the movement of a person is effected.

Added to this is the general problem that it is precisely in the medical sector that the introduction of ultrasonic waves into the human body is met with a high degree of scepticism so that, particularly in the case of topical measurements, that is to say those for which there is no need for ultrasound to be caused to penetrate into a body, there is an increasing need for measurement methods with which it is possible to ensure that the body is not disadvantageously acted upon by ultrasonic waves.

### SUMMARY OF THE INVENTION

Therefore the object of the present invention is to develop an apparatus for detecting deformation and/or movement, based on ultrasonic spacing measurement, in such a way that it not only avoids loading the body itself with the ultrasound when used in connection with a human body, but it is also possible to avoid the disadvantages linked to directly applying the ultrasonic sensors to the object to be measured, for example the skin of a patient (especially concerning the disadvantageous influences of the measurement signal, which are linked thereto). Another object of the present invention is to further develop a known apparatus in regard to universality and simplicity of the use thereof, while in particular another object is to ensure a predetermined spacing between the pair of sensor units in a reproducible manner and independently of a respective surface of the object to be measured, on which the procedure is based.

That object is attained by the apparatus having the features of the main claim; advantageous developments of the invention are set forth in the appendant claims.

### BRIEF DESCRIPTION OF THE DRAWINGS

Further advantages, features and details of the invention will be apparent from the description hereinafter of preferred embodiments and with reference to the drawings in which:

FIG. 1: A diagrammatic view of the apparatus according to the invention for producing measurement data with an individual pair of sensor units and an ultrasound-conducting extensible spacing medium and downstream-connected functional units,

FIG. 2: A diagrammatic view of the application of the spacing measurement apparatus to an article of clothing (20); after the article of clothing is put on the length L1 is pre-stretched in relation to L0 (L1>L0),

FIG. 3: A view showing the displacement of the positions and spacings of the sensors of FIG. 1 as a reaction to a body movement,

FIG. 4: An alternative embodiment with two pairs of sensor units and a downstream-connected portable measuring and transmitting device,

FIG. 5: A signal-time graph of the pair of sensors shown in FIG. 2 in the case of body movements (see FIG. 3),

FIG. 6: A configuration by way of example of a plurality of sensor pairs and spacing media on a shirt or directly on the skin (21) for detecting and resolving complex body movements,

FIG. 7: An application by way of example of an ultrasonic spacing measuring strip to a chest belt (22) for the purposes of measuring vital parameters (for example respiration, heartbeat),

FIG. 8: The application by way of example of an ultrasound spacing measuring strip to a long beam (23) for the purposes of measuring the deformation of the beam under the action of a load,

FIG. 9: The configuration by way of example of a unit comprising two ultrasound spacing measuring strips on the abdominal wall of a pregnant woman (24) for the purposes of labor measurement,

FIG. 10: The application by way of example of two ultrasound spacing measuring strips in the seat surface and the backrest of an automobile seat (25) for the purposes of seat occupancy recognition and driver position recognition, and

FIGS. 11-14: Configurations by way of example of the arrangement of a plurality of ultrasound spacing measuring strips for measuring complex movement or deformation conditions; it is also possible to envisage configurations comprising these and the arrangements shown in FIGS. 1, 6 and 9.

### DETAILED DESCRIPTION OF PREFERRED EMBODIMENT(S)

In an advantageous manner in accordance with the invention, the sensor units are held in a holding device which itself in turn has the elastic or deformable spacing medium according to the invention; in addition, the pair of sensor units can be fixed to the object to be measured in question, that is to say for example the body of a patient, by way of the fixing unit according to the invention (preferably by way of the holding device).

This procedure embodies a series of advantages over the state of the art: not only does the holding device permit the pair of sensor units to be held at a spacing which is clearly defined by the holding device itself (irrespective of a nature of the subjacent surface of the object to be measured), but also by virtue of the appropriate choice of the spacing medium of the holding device (in a preferred embodiment the holding device is formed by the spacing medium itself, that is to say the material forming the medium), a clear propagation path is defined in a known, ultrasound-conductive medium, whereby the quality of transmission and accordingly the quality of measurement of the system according to the invention can be optimised. A corresponding consideration applies in regard to deformation or distortion properties which are defined or can be defined by a suitable choice of material, in respect of the deformation section defined by the holding device or the spacing medium, between the pair of sensor units: here there are virtually any possible ways of tailoring the apparatus, by a suitable choice of material, to a large number of possible situations of use, in which respect a high level of operational reliability can be combined with a very simple structural implementation and substantial protection from detrimental ambient and environmental influences.

That applies in particular for a preferred embodiment of the present invention whereby the spacing medium is formed from non-biological material, for example rubber or silicone rubber, and is of a strip-shaped configuration; the respective sensor units are carried (preferably being removably fixed) at the ends of the respective strip, in which respect in this example the spacing medium itself also performs the function of the holding device according to the invention (alternatively for example it would be possible to envisage a strip-shaped, flexible plastic sheath or cover accommodating an easily deformable gel as the spacing medium). Such a strip can be particularly suitably fixed to a subjacent object to be measured, by means of the adhesive or bonding surface provided in accordance with a further development, whereby then movements of a surface of the object being measured are transmitted to the spacing medium or the holding device, and there provide for deformation which is reflected in a change in the spacing of the sensor unit and can be correspondingly evaluated as a movement or deformation signal by the measuring unit.

It will be self-evident that, comparable in function for example to a strain gauge, this embodiment of the invention means that it is possible to cover numerous examples of use, from the medical-diagnostic sector to the vehicle or building sector, and only the physical dimensions and deformation parameters of the holding device or the spacing medium are to be suitably adapted to the purpose of use involved.

Technically, it has been found to be particularly preferable for the sensor unit to be in the form of piezoelectric sensors and for a radial oscillation of such a sensor to be coupled into the transmission medium. That procedure makes it possible for the apparatus according to the invention to be of a particularly flat design and thus additionally to enlarge the practical range of uses.

In order further to reduce the possibility of ultrasonic waves passing into the object to be measured itself, it is provided in accordance with a further development that the holding device is provided with a damping and/or reflection layer which is between the sensor unit and the surface of the object to be measured; typically that could be an air chamber or a comparable cavity in the holding device which almost completely reflects ultrasonic waves. Besides the intended further reduction in terms of ultrasonic waves passing into the subjacent object to be measured (the propagation of ultrasound occurs in any case preferably along the especially adapted spacing medium), that affords the effect of a further improvement in signal quality by virtue of suppressing unwanted reflections from the object to be measured itself.

Depending on the respective area of use, it is also appropriate for the measuring unit to be in the form of a component part of a portable, in particular battery-operated unit, which is connectable to a stationary base unit preferably by means of a wireless data connection for the transmission of a suitable evaluation signal and/or further signals. Numerous procedures are known from the state of the art for providing for wireless transmission of signals efficiently, with a high level of reliability and at comparatively low cost here, so that, particularly also when using the present invention in the area of measuring movements at the surface of a human body, here the person in question is scarcely impaired in terms of their freedom of movement.

In that respect, in accordance with the present invention the choice of terminology ‘pair of sensor units’ is to be interpreted as meaning that, over and above two sensor units which are related to each other or cooperate as transmitter and receiver, here additional pairs of sensor units can also co-operate in the context of an overall system and can be jointly evaluated; in that respect the term ‘pair’ is also to be taken to mean an arrangement in which an (active) sensor unit performs both a transmitter and a receiver function while a (or a plurality of) respective other sensor units act as—defined—reflectors at the other end of the transmission channel defined by the spacing medium and in that respect admittedly themselves do not emit or receive ultrasonic waves, but definedly return the transmission signal for electronic evaluation. Here, depending on the respective situation of use, no limits are imposed both in regard to the number of reflectors and also in regard to the number of transmitting/receiving elements.

Besides the claimed uses it will be apparent that the present invention is suitable for example in particular also in the region of rehabilitation or work with the handicapped. When suitably applied for example to or on a body of a handicapped person, the present invention permits the handicapped person to execute predetermined control purposes, within the limits of the motor activity available to him, and they can then be converted into appropriate functions and actions.

The main suitability of the present invention should also be emphasised, in particular in the preferred implementation in the form of a strip-shaped arrangement, as a strain gauge: it is precisely in relation to flying objects in which for example a material loading due to loads and manoeuvring is particularly critical (for instance the example of a cargo lifter with in part critical deformation at very widely varying locations of the fuselage under load) clearly shows a meaningful practical area of use of the present invention. The same applies in regard to heavy machines, for example load cranes, load shelf arrangements and so forth, as well as continuous monitoring for deformation or material stressing.

Alternatively it is possible for the present invention also to be applied to microstructures, and there also for detecting movement and sound conditions as well as deformation phenomena.

The advantageous possibility of embedding the pair of sensor units into the holding device (which preferably comprises the spacing medium itself) also provides that in that way it is possible to afford an arrangement which is advantageously protected from environmental influences such as moisture and fouling, so that here there is additionally a potential for any capacity for use. In terms of practical implementation possible embodiments are those which provide for operation of the present invention under water.

Accordingly the present invention makes it possible in a surprisingly simple and elegant manner to detect virtually any movements, force influences, actuating, regulating, adjusting and switching movements as well as weight loadings reliably and with a low level of complication and cost and to pass such parameters to further electronic evaluation procedures. As will be apparent from the uses to be described in detail hereinafter and also recited in the claims, the area of use of the present invention is broad and affords the possibility of using the present technology in an advantageous manner for a large number of detection situations in the ordinary everyday and industrial sphere without risk and dangers or excessive loadings and stresses occurring due to the procedure according to the invention.

FIG. 1 shows an apparatus for producing measurement data concerning movements and/or vital parameters of a person, or deformations of components, structural groups in accordance with the invention with at least one pair of sensor units 1, 2 which are arranged at a spacing L1 from each other and which are connected to each other by an ultrasound-conducting, stretchable spacing medium 3. That spacing medium can be made for example from rubber, gel or the like and in the present example comprises silicone rubber.

The apparatus can be applied directly or indirectly to the object to be measured in such a way that the sensor units 1, 2 are in fixed relationship with the location of application, their spacing changes according to the movements or deformations of the object being measured, and the spacing medium 3 is correspondingly extended.

Associated with the sensor unit of the present invention are a transmitter and a receiver of an ultrasound distance measuring unit which in otherwise known manner, on the basis of the transit time differences of the ultrasound signal which are caused by body movements and/or changes in posture of the person or deformation of the components/structural groups, produces a corresponding signal which is suitable for further evaluation.

This apparatus affords a process for detecting body movements or component deformation, which however does not have to be applied directly to the skin so that the skin does not act as a transmission medium for the ultrasound.

Associated with the apparatus is a distance measuring unit 10 which is adapted to detect electrically evaluatable signals of the unit comprising sensors and spacing medium and produces a first spacing signal and the change therein.

Connected on the output side of the distance measuring unit is a storage unit 11 which serves for data storage of the spacing signals which are updated at a fixed or adjustable sampling rate and which can be outputted by means of an output unit 14 for further processing or display.

The apparatus further includes an evaluation unit 12 which permits the detection of given signal shapes or signal shape changes, as are characteristic for example in regard to describing vital parameters of a person.

Further associated with the apparatus is a communication unit 13 which permits wired or wireless connection of the apparatus to an additional base station for monitoring and evaluating the measurement data.

The downstream-connected units 10 through 14 shown in FIG. 1 can be portably integrated into the sensor unit 1, 2 and/or the spacing medium or alternatively can be in the form of a downstream-connected, separate measuring and transmission device.

FIG. 1 diagrammatically shows the application of the apparatus which in the simplest situation of same merely comprises a pair of sensor units and a spacing medium; the further Figures show variants with a plurality of pairs of sensor units in accordance with the invention.

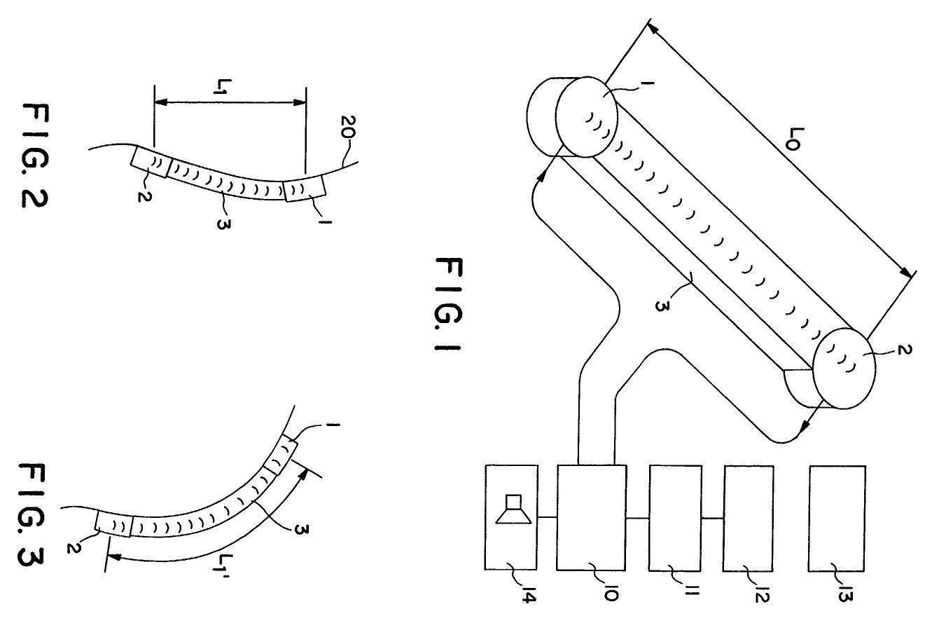

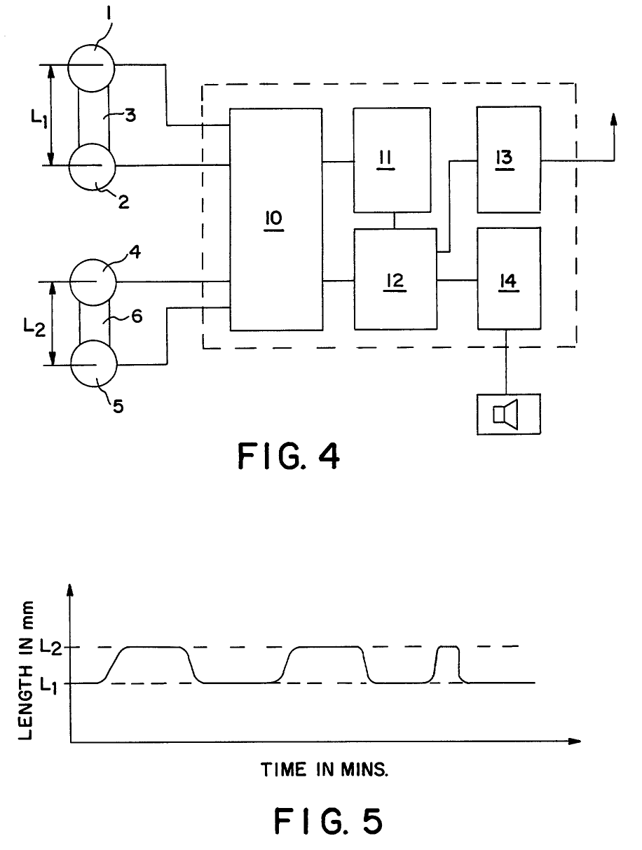

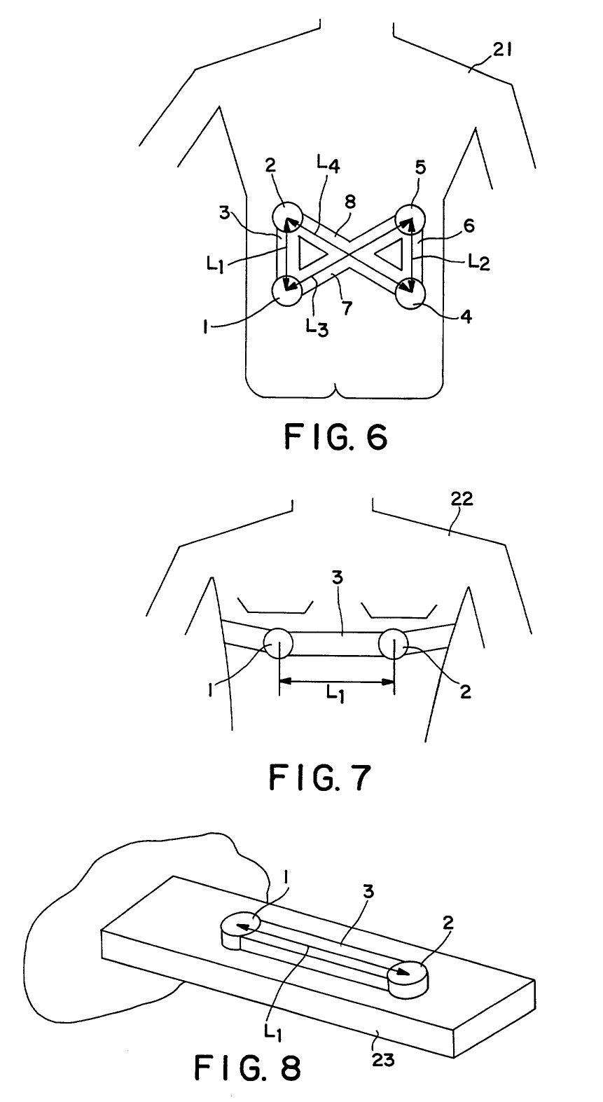

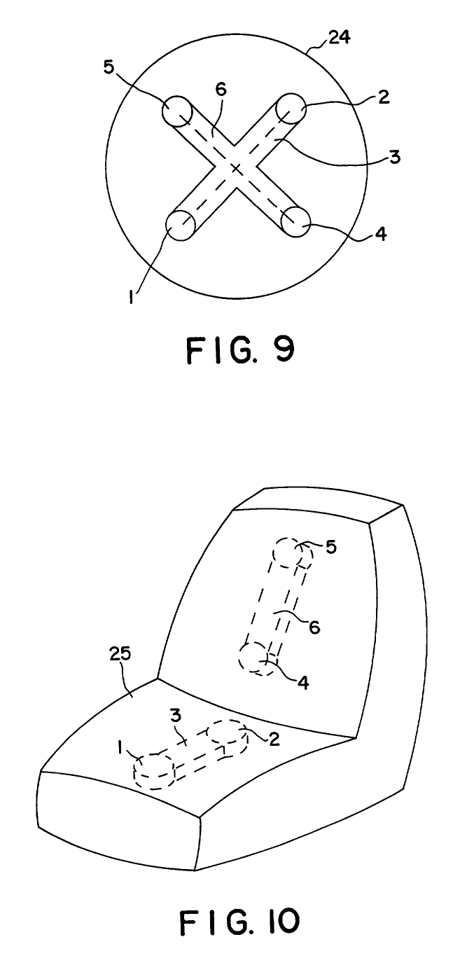

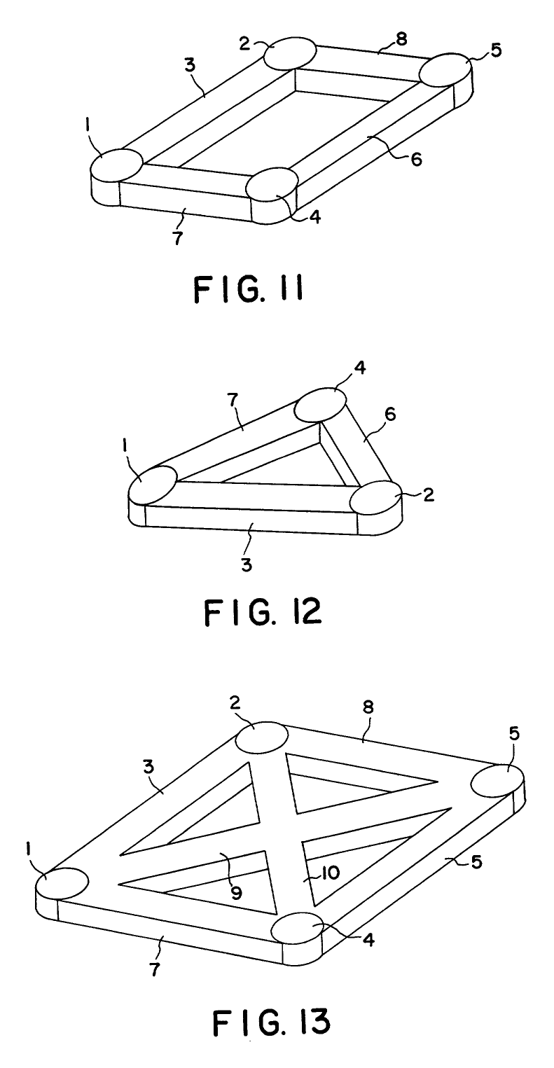

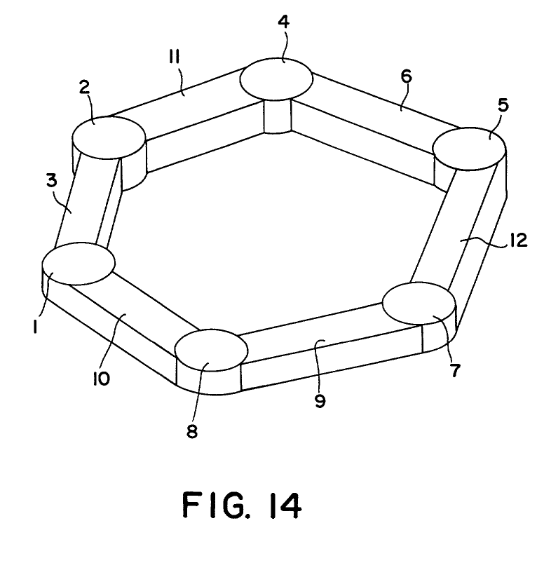

In FIG. 2 the apparatus is applied by way of example to the clothing of a person. The article of clothing 20 fits closely and follows the body movements or changes in posture of the person in such a way that the sensor spacing L1 changes in accordance with displacements of the skin as the spacing medium is stretched together with the article of clothing in a corresponding manner. The apparatus is fixed to the clothing in the prestressed condition (L1>L0) in order thus also to be able to detect reductions in spacing (L1′<L1) on the assumption of (L1′>L0).

The advantages of the apparatus and process in comparison with the state of the art are apparent:

no skin contact required,

no radiation of ultrasound intensity into the body,

no coupling connection problems (transfer resistance),

simple fixing (detection options in brackets):

incorporation in a belt (respiration, body posture, . . . )

in an article of clothing (respiration, body posture, labor, shoulder and elbow joint angle, . . . ),

in trousers (leg angle, knee angle, . . . ),

in shoes (pace counter, ),

in gloves (joint angle, . . . ),

fixing by means of a hook-and-loop strip or the like to articles of clothing,

fixing by glueing or sewing or the like on/to components,

etc,

measuring large deformation on extended components/structural groups.

Further possible forms of use are illustrated in the Figures; the various embodiments of the invention are suitable for detecting by way of example the following parameters:

body posture,

labor,

motion tracking (joint movements, etc),

seat occupancy,

deformation characteristics of components and structural groups (for example lightweight constructions, supporting surfaces or airfoils, etc),

respiration.

With further embodiments which are not shown in Figures the detection of for example the following parameters is possible:

step frequencies, pace frequencies, switching conditions of pushbutton or key switches and switches (single-stage and multi-stage),

input devices,

biofeedback devices,

etc.

1. Apparatus for deformation and/or movement detection, comprising
a pair of preferably piezoelectrically acting sensor units co-operating on an ultrasound basis, and
an electronic measuring unit which is connected downstream of the pair of sensor units and which is adapted to produce a deformation or movement signal on the basis of electronically evaluatable signals of the sensor units, corresponding to a change in spacing between the pair of sensor units,
characterized in that
associated with the pair of sensor units is a fixing unit for releasably fixing the sensor units to an object to be measured, in particular to a part of the body of a person, and the pair of sensor units is ultrasound-conductingly connected by a holding device which has an elastic and/or deformable spacing medium and which is so adapted that deformation of the spacing medium to produce the deformation or movement signal is detectable by the measuring unit.

2. Apparatus as set forth in claim 1 characterized in that the spacing medium has a non-biological, in particular non-human or non-animal material, and is selected in particular from the group consisting of rubber, silicone rubber, gel or mixtures of those.

3. Apparatus as set forth in claim 1 characterized in that the holding device having the spacing medium is adapted for releasably or non-releasably accommodating the pair of sensor units and/or comprises the spacing medium itself.

4. Apparatus as set forth in claim 1 characterized in that the holding device having the spacing medium is of a strip-shaped configuration and holds the pair of sensor units in the region of respective narrow sides of the strip.

5. Apparatus as set forth in claim 1 characterized in that the holding device has a preferably releasable adhesive and/or bonding region as a fixing unit, with which the apparatus is preferably removably fixable on the object to be measured.

6. Apparatus as set forth in claim 1 characterized in that one of the pair of sensor units is in the form of an ultrasound sensor and/or ultrasound receiver acting on a piezoelectric basis.

7. Apparatus as set forth in claim 1 characterized in that one of the pair of sensor units is in the form of a passively acting reflector for a signal, conducted through the spacing medium, of the other of the pair of sensor units.

8. Apparatus as set forth in claim 1 characterized in that the holding device and the sensor units are adapted for coupling a radial oscillation of a sensor unit which in particular is in the form of a piezoelectric sensor, into the spacing medium.

9. Apparatus as set forth in claim 1 characterized by a damping and/or reflection layer between the sensor unit and the object to be measured, said layer being associated with at least one of the pair of sensor units.

10. Use of the apparatus as set forth in claim 1 as a switch, regulating or control member reacting to preferably manual actuation of an operator in the region of the holding device.

11. Use of the apparatus as set forth in claim 1 for flexural, tensile, shearing strain and/or torsional detection on vehicles, furniture or parts of buildings.

12. Use of the apparatus as set forth in claim 1 for detecting movement and other body parameters of a person or an animal.

13. Use of the apparatus as set forth in claim 1 at or under a seating or lying surface for detecting occupancy of a corresponding seat or a couch and/or for detecting movement of a person on the seating or lying surface.

14. Use of the apparatus as set forth in claim 1 on an article of clothing or as part of an article of clothing for the detection of a movement or a body parameter expressed as movement of a person wearing the article of clothing.

15. Use of the apparatus as set forth in claim 1 with a wristwatch or a bracelet, wherein the holding device acts as the bracelet and is connected in force-locking and/or positively locking relationship to a body region of a wearer and is adapted for the detection of heartbeat-governed deformations or movements of the spacing medium in the holding device.

16. Use of the apparatus as set forth in claim 1 as part of a head frame in contact with a head region, in particular a spectacles frame, wherein the holding device can be brought into contact with the head in such a way that a movement of a blood vessel can be detected from the head surface by the holding device and can be evaluated in particular as a heartbeat signal by the measuring unit.
